(19) United States
(12) Patent Application Publication
(10) Pub. No.: US 2012/0103446 A1
(43) Pub. Date: May 3, 2012

(54) Air Pressure Producing Apparatus

(75) Inventors: Ming-Hung Chou, Xinyi District (TW); Ching-Feng Hsieh, Wanhua District (TW)

(73) Assignee: Askey Computer Corporation, Chung-Ho (TW)

(21) Appl. No.: 12/958,934

(22) Filed: Dec. 2, 2010

(30) Foreign Application Priority Data
Oct. 27, 2010 (TW) 99136654

(51) Int. Cl. F15D 1/00

(52) U.S. Cl. 137/565.16

(57) ABSTRACT

An air pressure producing apparatus includes: a vacuum pump having a negative pressure terminal and a positive pressure terminal; a first solenoid valve having a first intake terminal and a first exhaust terminal connected to the negative pressure terminal of the vacuum pump; a second solenoid valve having a second exhaust terminal and a second intake terminal connected to the positive pressure terminal of the vacuum pump; and a control unit connected to the vacuum pump, the first solenoid valve and the second solenoid valve for controlling the vacuum pump to extract air at the negative pressure terminal thereof so as to produce a negative pressure at the first intake terminal of the first solenoid valve and controlling the vacuum pump to exhaust air at the positive pressure terminal thereof so as to produce a positive pressure at the second exhaust terminal of the second solenoid valve.

### BACKGROUND OF THE INVENTION

1. Field of the Invention

The present invention relates to air pressure producing apparatus capable of producing positive and negative pressure sources, and more particularly, to an air pressure producing apparatus capable of producing stable positive/negative pressure sources using a single vacuum pump.

2. Description of Related Art

Currently, a variety of electronic products have a waterproof or moisture-proof function, such as waterproof digital watches, waterproof mobile phones, waterproof digital cameras and so on, and more and more electronic products are desired to have a waterproof or moisture-proof function.

Generally, a waterproof or moisture-proof test is performed on an object by applying an air pressure on junctions between components of the object, wherein the air pressure is used to simulate a water pressure. For example, a negative pressure or a positive pressure can be applied on the junctions and a pressure sensor can be used to sense the pressure that is maintained by the object. Once the object cannot maintain a certain degree of pressure, it represents that the object is leaking air and has poor waterproof or moisture-proof performance.

To perform the above-described test method, devices for producing negative and positive pressures are required. Generally, a vacuum pump is necessary for producing a negative pressure and an air compressor is necessary for producing a positive pressure. However, the use of the two types of apparatus is costly and space-consuming. Further, the accuracy of the air pressure produced by the air compressor is lower than the vacuum pump, thereby making it difficult to accurately regulate the positive pressure in the prior art.

### SUMMARY OF THE INVENTION

Accordingly, the present invention provides an air pressure producing apparatus capable of producing stable negative and positive pressure sources.

In order to achieve the above and other objects, the present invention provides an air pressure producing apparatus, which comprises: a vacuum pump having a negative pressure terminal and a positive pressure terminal; a first solenoid valve having a first intake terminal and a first exhaust terminal, wherein the first exhaust terminal is connected to the negative pressure terminal of the vacuum pump; a second solenoid valve having a second intake terminal and a second exhaust terminal, wherein the second intake terminal is connected to the positive pressure terminal of the vacuum pump; and a control unit connected to the vacuum pump, the first solenoid valve and the second solenoid valve for controlling the vacuum pump to extract air at the negative pressure terminal thereof so as to produce a negative pressure at the first intake terminal of the first solenoid valve and controlling the vacuum pump to exhaust air at the positive pressure terminal thereof so as to produce a positive pressure at the second exhaust terminal of the second solenoid valve.

Since the air pressure producing apparatus of the present invention produces a vacuum pressure (negative pressure) and an air pressure (positive pressure) through a single vacuum pump, it eliminates the need of two types of apparatus as in the prior art, thereby saving the cost and space and facilitating the test.

### BRIEF DESCRIPTION OF DRAWINGS

FIG. 1 is a schematic block diagram illustrating the basic architecture of an air pressure producing apparatus according to an embodiment of the present invention;

FIG. 2 is a schematic block diagram illustrating the basic architecture of an air pressure producing apparatus according to another embodiment of the present invention;

FIG. 3 is a schematic block diagram illustrating the basic architecture of an air pressure producing apparatus according to a further embodiment of the present invention;

FIG. 4 is a schematic block diagram illustrating the basic architecture of an air pressure producing apparatus according to another embodiment of the present invention; and

FIG. 5 is a schematic block diagram illustrating the basic architecture of an air pressure producing apparatus according to a further embodiment of the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

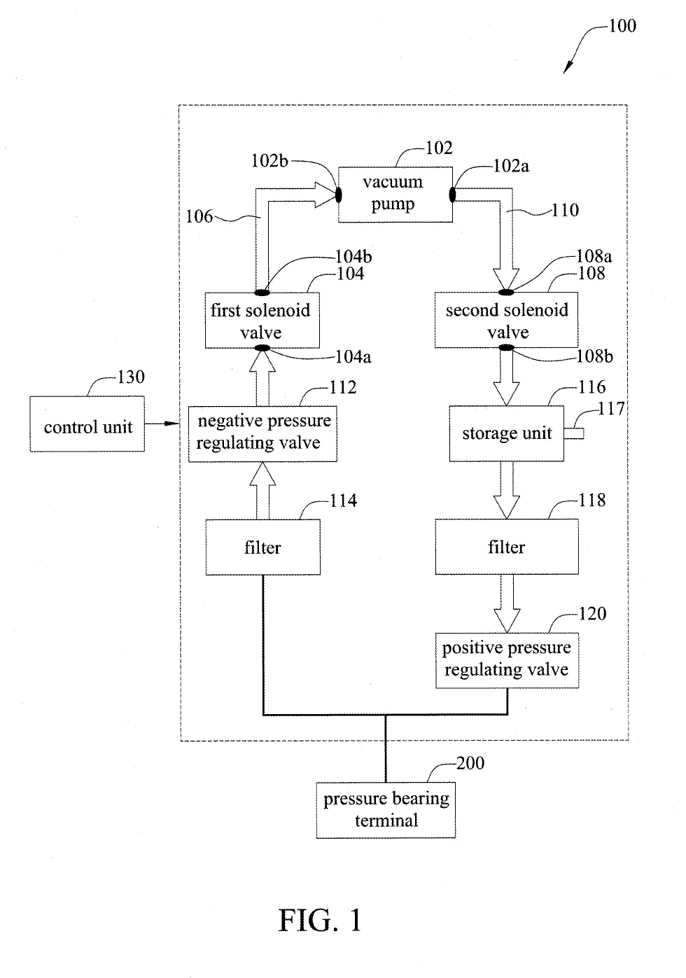

FIG. 1 is a schematic block diagram illustrating the basic architecture of an air pressure producing device 100 according to an embodiment of the present invention. Referring to FIG. 1, the air pressure producing device 100 comprises: a vacuum pump 102 having a positive pressure terminal 102a and a negative pressure terminal 102b; a first solenoid valve 104 having a first intake terminal 104a and a first exhaust terminal 104b, wherein the first exhaust terminal 104b of the first solenoid valve 104 is connected to the negative pressure terminal 102b of the vacuum pump 102 through a first pipeline 106; a second solenoid valve 108 having a second intake terminal 108a and a second exhaust terminal 108b, wherein the second intake terminal 108a of the second solenoid valve 108 is connected to the positive pressure terminal 102a of the vacuum pump 102 through a second pipeline 110; a negative pressure regulating valve 112 connected to the first intake terminal 104a of the first solenoid valve 104; a filter 114 connected to the negative pressure regulating valve 112; a storage unit 116 connected to the second exhaust terminal 108b of the second solenoid valve 108; a filter 118 connected to the storage unit 116; a positive pressure regulating valve 120 connected to the filter 118; and a control unit 130 electrically connected to the vacuum pump 102, the first solenoid valve 104 and the second solenoid valve 108. The air pressure producing apparatus 100 is used to perform a vacuum process (negative pressure producing process) or an air pressurizing process (positive pressure producing process) to a pressure bearing terminal 200. The pressure bearing terminal 200 can be an object to which a positive or negative pressure test is to be performed. In particular, the pressure bearing terminal 200 can be an electronic product to which a waterproof or moisture-proof test is to be performed.

Referring to the drawing, the negative pressure terminal 102b of the vacuum pump 102, the first solenoid valve 104, the first pipeline 106, the negative pressure regulating valve 112 and the filter 114 constitute a negative pressure producing path. Similarly, the positive pressure terminal 102a of the vacuum pump 102, the second solenoid valve 108, the second pipeline 110, the storage unit 116, the filter 118 and the positive pressure regulating valve 120 constitute a positive pressure producing path.

The control unit 130 is electrically connected to the vacuum pump 102, the first solenoid valve 104 and the second solenoid valve 108 for controlling the driving of these components.

The vacuum pump 102 controlled by the control unit 130 can extract air at the negative pressure terminal 102b thereof so as to produce a vacuum pressure (negative pressure) at the first intake terminal 104a of the first solenoid valve 104. Also, the vacuum pump 102 can exhaust air at the positive pressure terminal 102a thereof so as to produce a positive pressure at the second exhaust terminal 108b of the second solenoid valve 108.

The negative pressure regulating valve 112 connected to the first intake terminal 104a of the first solenoid valve 104 is used for regulating the negative pressure in the negative pressure producing path constituted by the first intake terminal 104a, the first exhaust terminal 104b, the negative pressure terminal 102b and the first pipeline 106. The filter 114 connected to the negative pressure regulating valve 112 is used for filtering out impurities such as moisture, oil and dust existing in the negative pressure producing path. In an embodiment, the filter 114 is disposed close to the pressure bearing terminal 200. As such, when a negative pressure producing process is performed on the pressure bearing terminal 200, impurities in the pressure bearing terminal 200 are prevented from being introduced into the vacuum pump 102, which otherwise could cause damage to the vacuum bump 102. The storage unit 116 connected to the second exhaust terminal 108b of the second solenoid valve 108 is used for storing the air pressure produced by the vacuum pump 102. In practice, since moisture is produced when air is compressed, the air pressure is stored in the storage unit 116 such that moisture is produced in the storage unit 116, thereby protecting the vacuum pump 102 from being adversely affected by the moisture. Further, in a preferred embodiment, a pressure switch 117 is disposed on the storage unit 116 and controlled by the control unit 130 for enabling or disabling air exhaust to the storage unit 116. In particular, the pressure switch 117 is used for maintaining the air pressure in the storage unit 116. If the air pressure is not sufficient, the pressure switch 117 enables air exhaust from the vacuum pump 102 to the storage unit 116 so as to increase the air pressure. In practice, the pressure switch 117 controls the air exhaust from the vacuum pump 102 to the storage unit 116 through the control unit 130. The positive pressure regulating valve 120 connected to the filter 118 is used for regulating the air pressure (positive pressure) provided by the storage unit 116. The filter 118 connected to the storage unit 116 is used for filtering out impurities such as moisture, oil and dust in air exhausted from the storage unit 116. In an embodiment, the filter 118 is disposed close to the storage unit 116. As such, when a positive pressure producing process is performed on the pressure bearing terminal 200, impurities or moisture in the storage unit 116 is prevented from being introduced into the pressure bearing terminal 200, which otherwise could adversely affect the pressure bearing terminal 200.

Preferably, the positive pressure required by the pressure bearing terminal 200 is directly supplied by the storage unit 116, and when the air pressure in the storage unit 116 is not sufficient to provide the required positive pressure, the vacuum pump 102 is controlled to exhaust air to the storage unit 116.

As described above, if the pressure bearing terminal 200 is an electronic product to which a waterproof or moisture-proof test is to be performed, the air pressure producing apparatus 100 can further comprise a pressure sensor (not shown) for sensing the negative or positive pressure born by the pressure bearing terminal 200. Furthermore, the pressure sensor can sense the negative pressure in the negative pressure producing path constituted by the first intake terminal 104a, the first exhaust terminal 104b, the negative pressure terminal 102b and the first pipeline 106. In addition, the pressure sensor can sense the positive pressure provided by the storage unit 116.

For example, if the negative pressure in the negative pressure producing path constituted by the first intake terminal 104a, the first exhaust terminal 104b, the negative pressure terminal 102b and the first pipeline 106 is lower than the user's requirement, the control unit 130 controls the vacuum pump 102 to extract air at the negative pressure terminal 102b thereof and meanwhile controls the first solenoid valve 104 so as to increase the negative pressure at the first intake terminal 104a of the first solenoid valve 104.

On the contrary, if the negative pressure in the negative pressure producing path is higher than the user's requirement, the control unit 130 controls the negative pressure regulating valve 112 to regulate air flowing into the first intake terminal 104a so as to decrease the negative pressure.

On the other hand, if the positive pressure in the storage unit 116 is too low, the control unit 130 controls the vacuum pump 102 to exhaust air at the positive pressure terminal 102a (the exhaust operation is performed through the pressure switch 117) and meanwhile controls the second solenoid valve 108 so as to produce a positive pressure at the second intake terminal 108a of the second solenoid valve 108 and thereby supplement the air pressure within the storage unit 116.

Further, if the positive pressure provided by the storage unit 116 to the pressure bearing terminal 200 is lower than the user's requirement, the control unit 130 controls the positive pressure regulating valve 120 to regulate or increase the positive pressure provided by the storage unit 116.

On the contrary, if the positive pressure provided by the storage unit 116 to the pressure bearing terminal 200 is higher than the user's requirement, the control unit 130 controls the positive pressure regulating valve 120 so as to regulate or reduce the positive pressure provided by the storage unit 116. In the present embodiment, the storage unit 116 is used to store and compress air exhausted from the vacuum pump 102. Moisture produced during the air compression is stored in the storage unit 116 without adversely affecting the vacuum pump 102. The positive pressure regulating valve 120 is used to regulate the air pressure in the positive pressure producing path constituted by the second solenoid valve 108, the storage unit 116 and the filter 118.

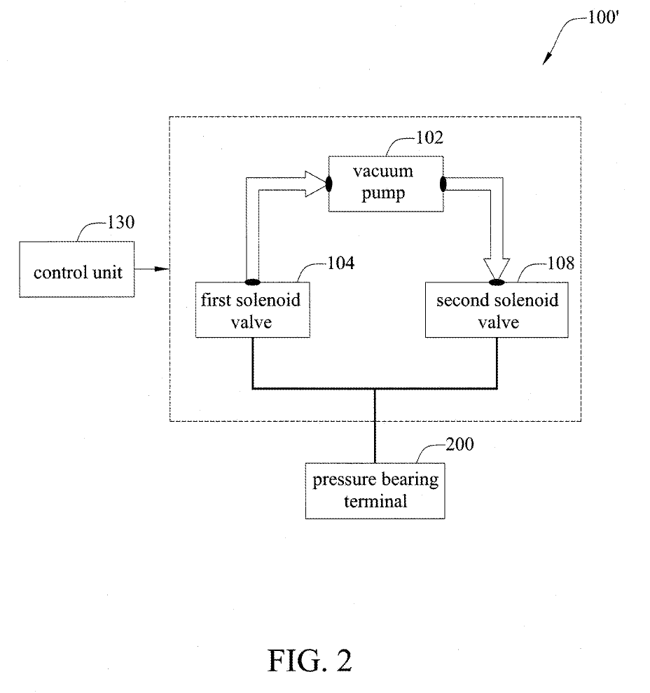

FIG. 2 shows the basic architecture of an air pressure producing apparatus 100′ according to another embodiment of the present invention. For the purpose of simplification, only the difference of the present embodiment from the embodiment of FIG. 1 is described herein. The air pressure producing apparatus 100′ of the present embodiment omits the negative pressure regulating valve 112, the filter 114, the storage unit 116, the filter 118 and the positive pressure regulating valve 120 of FIG. 1. But the apparatus 100′ still can control the driving of the vacuum pump 102, the first solenoid valve 104 and the second solenoid valve 108 through the control unit 130 so as to perform a negative or positive pressure producing process to the pressure bearing terminal 200.

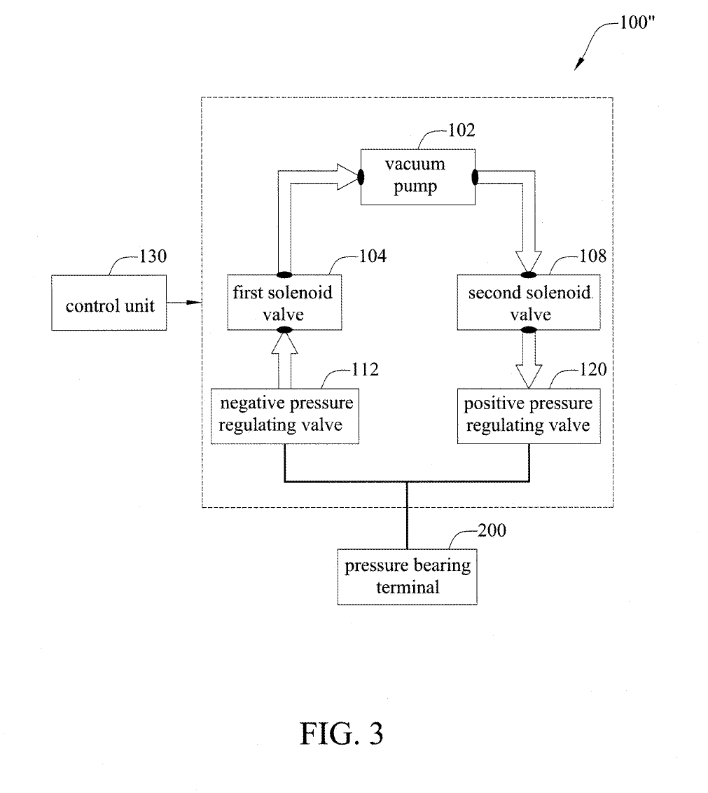

FIG. 3 shows the basic architecture of an air pressure producing apparatus 100″ according to a further embodiment of the present invention. For the purpose of simplification, only the difference of the present embodiment from the embodiment of FIG. 1 is described herein. The apparatus 100″ of the present embodiment omits the filter 114, the storage unit 116 and the filter 118 of FIG. 1. Compared with FIG. 1, although the present embodiment lacks a function of filtering out impurities in the negative or positive pressure producing path, the apparatus 100″ still can control the driving of the vacuum pump 102, the first solenoid valve 104, the negative pressure regulating valve 112, the second solenoid valve 108 and the positive pressure regulating valve 120 through the control unit 130, thereby performing a negative or positive pressure producing process to the pressure bearing terminal 200 and regulating the negative or positive pressure through the negative pressure regulating valve 112 or the positive pressure regulating valve 120.

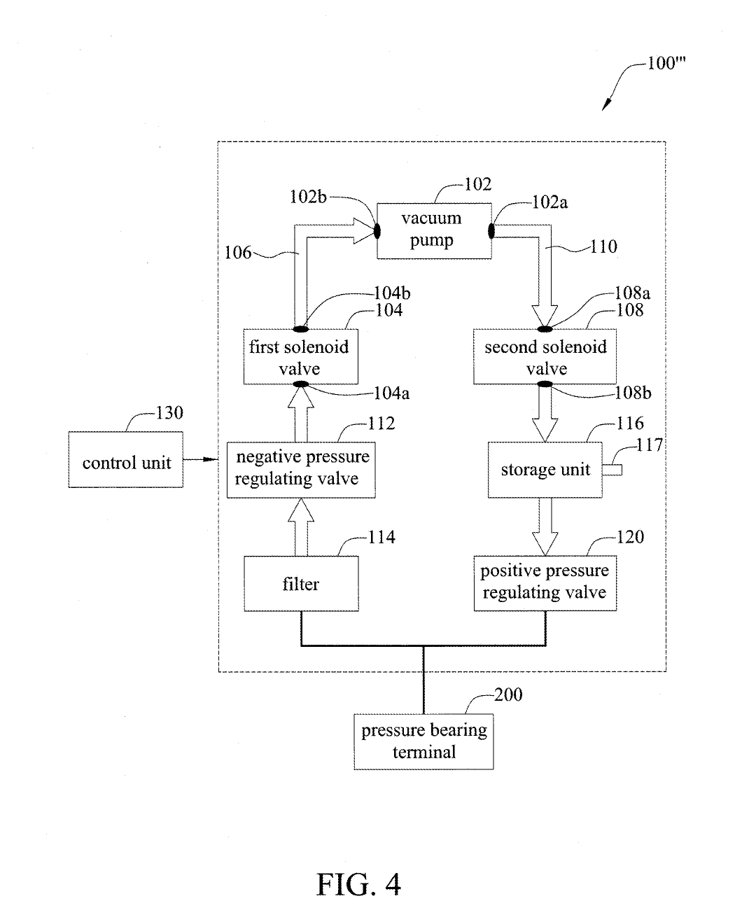

FIG. 4 shows the basic architecture of an air pressure producing apparatus 100′″ according to another embodiment of the present invention. For the purpose of simplification, only the difference of the present embodiment from the embodiment of FIG. 1 is described herein. The apparatus 100′″ of the present embodiment omits the filter 118 of FIG. 1. The positive pressure regulating valve 120 is connected to the storage unit 116 for regulating the positive pressure provided by the storage unit 116 to the pressure bearing terminal 200.

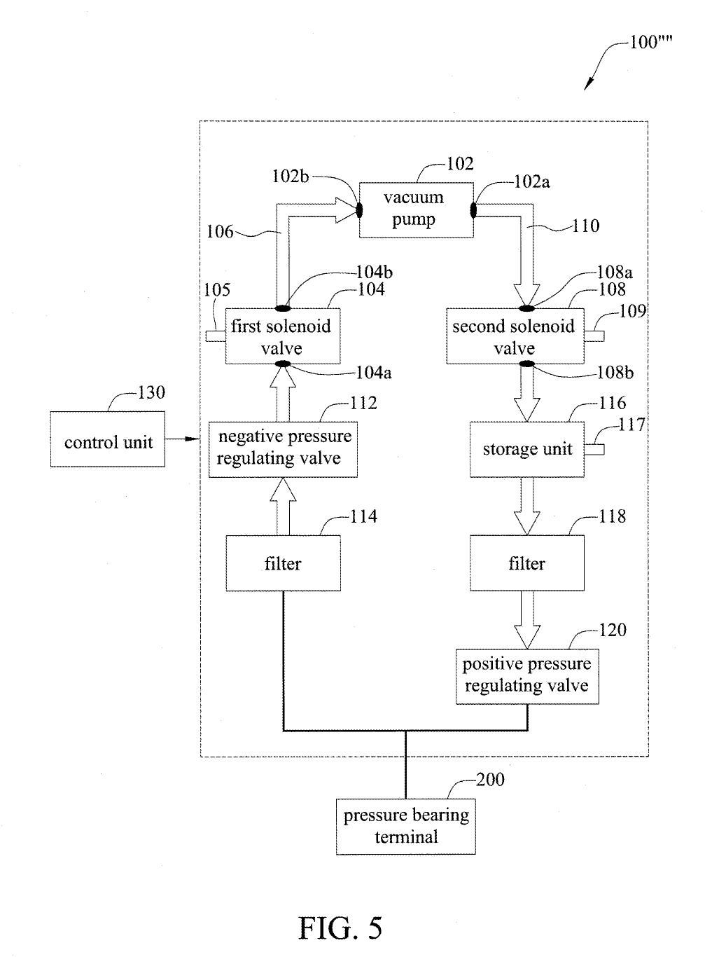

FIG. 5 shows the basic architecture of an air pressure producing apparatus 100″″ according to another embodiment of the present invention. For the purpose of simplification, only the difference of the present embodiment from the embodiment of FIG. 1 is described herein. The apparatus 100″″ of the present embodiment further comprises a first muffler 105 disposed on the first solenoid valve 104 and a second muffler 109 disposed on the second solenoid valve 108. The control unit 130 controls the first exhaust terminal 104b of the first solenoid valve 104 to be selectively connected to the first intake terminal 104a and the first muffler 105, and controls the second intake terminal 108a of the second solenoid valve 108 to be selectively connected to the second exhaust terminal 108b and the second muffler 109. When the first exhaust terminal 104b is connected to the first intake terminal 104a and the second intake terminal 108a is connected to the second muffler 109, the pressure bearing terminal 200, the first intake terminal 104a, the first exhaust terminal 104b, the negative pressure terminal 102b, the vacuum pump 102, the positive pressure terminal 102a, the second intake terminal 108a and the second muffler 109 constitute a negative pressure producing path. As such, the apparatus 100″″ provides a negative pressure to the pressure bearing terminal 200. On the other hand, when the first exhaust terminal 104b is connected to the first muffler 105 and the second intake terminal 108a is connected to the second exhaust terminal 108b, the first muffler 105, the first exhaust terminal 104b, the negative pressure terminal 102b, the vacuum pump 102, the positive pressure terminal 102a, the second intake terminal 108a, the second exhaust terminal 108b and the pressure bearing terminal 200 constitute a positive pressure producing path. In the present embodiment, the apparatus 100″″ can exhaust air to the outside through the second muffler 109 during a negative pressure producing process so as to maintain a mass balance. On the other hand, the apparatus 100″″ can extract air from the outside through the first muffler 105 during a positive pressure producing process so as to maintain a mass balance.

Therefore, the air pressure producing apparatus of the present invention provides negative and positive producing paths and provides a vacuum pressure source and an air pressure source through a single vacuum pump. Therefore, the present invention eliminates the need of two types of apparatus for producing the vacuum pressure and the air pressure as in the prior art, thereby effectively saving the cost and space.

The above-described descriptions of the detailed embodiments are intended to illustrate the preferred implementation according to the present invention but are not intended to limit the scope of the present invention. Accordingly, all modifications and variations completed by those with ordinary skill in the art should fall within the scope of present invention defined by the appended claims.

What is claimed is:

1. An air pressure producing apparatus, comprising:
a vacuum pump having a negative pressure terminal and a positive pressure terminal;
a first solenoid valve having a first intake terminal and a first exhaust terminal, wherein the first exhaust terminal is connected to the negative pressure terminal of the vacuum pump;
a second solenoid valve having a second intake terminal and a second exhaust terminal, wherein the second intake terminal is connected to the positive pressure terminal of the vacuum pump; and
a control unit connected to the vacuum pump, the first solenoid valve and the second solenoid valve for controlling the vacuum pump to extract air at the negative pressure terminal thereof so as to produce a negative pressure at the first intake terminal of the first solenoid valve and controlling the vacuum pump to exhaust air at the positive pressure terminal thereof so as to produce a positive pressure at the second exhaust terminal of the second solenoid valve.

2. The apparatus of claim 1, wherein the air pressure producing apparatus provides one of a negative pressure and a positive pressure to a pressure bearing terminal that is connected to the first intake terminal of the first solenoid valve and the second exhaust terminal of the second solenoid valve, wherein the negative pressure terminal of the vacuum pump, the first solenoid valve connected to the negative pressure terminal, and the pressure bearing terminal connected to the first solenoid valve constitute a negative pressure producing path; and the positive pressure terminal of the vacuum pump, the second solenoid valve connected to the positive pressure terminal, and the pressure bearing terminal connected to the second solenoid valve constitute a positive pressure producing path.

3. The apparatus of claim 2, further comprising a negative pressure regulating valve disposed in the negative pressure producing path for regulating the negative pressure therein.

4. The apparatus of claim 2, further comprising a filter disposed in the negative pressure producing path for filtering air therein.

5. The apparatus of claim 4, wherein the filter is disposed close to the pressure bearing terminal.

6. The apparatus of claim 2, further comprising a storage unit disposed in the positive pressure producing path for storing air exhausted from the vacuum pump through the second exhaust terminal so as to apply a positive pressure on the pressure bearing terminal, and further comprising a pressure switch connected to the storage unit for enabling or disabling air exhausted from the vacuum pump to the storage unit.

7. The apparatus of claim 6, further comprising a positive pressure regulating valve connected to the storage unit for regulating the positive pressure applied by the storage unit on the pressure bearing terminal.

8. The apparatus of claim 2, further comprising a filter disposed in the positive pressure producing path for filtering air therein.

9. The apparatus of claim 2, further comprising a positive pressure regulating valve disposed in the positive pressure producing path for regulating the positive pressure therein.

10. The apparatus of claim 2, wherein the first solenoid valve comprises a first muffler, the second solenoid valve comprises a second muffler, the control unit controls the first exhaust terminal of the first solenoid valve to be selectively connected to the first intake terminal and the first muffler, and the control unit controls the second intake terminal of the second solenoid valve to be selectively connected to the second exhaust terminal and the second muffler, wherein, when the first exhaust terminal is connected to the first intake terminal and the second intake terminal is connected to the second muffler, the pressure bearing terminal, the first intake terminal, the first exhaust terminal, the negative pressure terminal, the vacuum pump, the positive pressure terminal, the second intake terminal and the second muffler constitute a negative pressure producing path; and when the first exhaust terminal is connected to the first muffler and the second intake terminal is connected to the second exhaust terminal, the first muffler, the first exhaust terminal, the negative pressure terminal, the vacuum pump, the positive pressure terminal, the second intake terminal, the second exhaust terminal and the second pressure bearing terminal constitute a positive pressure producing path.
